(19) United States
(12) Patent Application Publication
(10) Pub. No.: US 2025/0092601 A1
(43) Pub. Date: Mar. 20, 2025

(54) NOVEL VISIBLY TRANSPARENT AND INFRARED REFLECTIVE (VTIR) COATINGS

(71) Applicant: THE BOARD OF TRUSTEES OF THE UNIVERSITY OF ILLINOIS, URBANA, IL (US)

(72) Inventors: Lili CAI, Urbana, IL (US); Ho Kun WOO, Urbana, IL (US)

(21) Appl. No.: 18/339,891

(22) Filed: Jun. 22, 2023

Related U.S. Application Data
(60) Provisional application No. 63/354,530, filed on Jun. 22, 2022.

(51) Int. Cl. D06M 23/16; D06M 10/06; D06M 101/20; D06M 101/32

(52) U.S. Cl. CPC D06M 23/16; D06M 10/06; D06M 2101/20; D06M 2101/32; D06M 2200/00

(57) ABSTRACT

The present disclosure is directed to a visibly transparent infrared reflector (VTIR) configured for suppression of emitted infrared radiation for personal thermal management and thermal camouflage. The reflector being configured to enable independent control over optical properties in the visible spectral region. The VTIR coating is comprises using a nano-mesh patterning strategy combined with an oxide/metal/oxide (OMO) trilayer structure having an optimized hole size and coating thickness.

### CROSS-REFERENCE TO RELATED APPLICATIONS

This application claims priority to U.S. Application No. 63/354,530 filed on Jun. 22, 2022, the contents of which are hereby incorporated by reference in its entirety.

### FIELD OF THE INVENTION

The field of the invention relates generally to advanced textile coatings, and the preparation and use thereof.

### BACKGROUND

Tailoring thermal radiation using low-infrared-emissivity materials has drawn significant attention for diverse applications, such as passive radiative heating and thermal camouflage. However, one drawback of low-infrared-emissivity materials have the visible optical properties cannot be independently controlled.

A material where thermal radiation heat transfer & visible optic properties can be independently controlled would yield great potential to make a significant impact on personal heat management and counter-surveillance applications.

As extreme weather events become more frequent and intense due to climate change, maintaining thermal comfort presents great challenges for society, especially in regions where air conditioners are not readily available. For instance, the winter storm in February 2021 caused power grids to fail across the U.S., leaving millions without access to electricity and heating, which resulted in $20.4 billion damage and more than 164 casualties. It is anticipated that the energy demand for space cooling and heating will more than triple by 2050. For building-level temperature regulation using heating, ventilation, air conditioning (HVAC) systems, enormous energy is wasted towards the empty space rather than the immediate environment of occupants. In addition, traditional HVAC systems use refrigerants with high global warming potential, imposing adverse impacts on the climate.

To address the challenges with climate change and energy crisis, energy-efficient and environment-friendly solutions for maintaining the thermal comfort of the human body need to be developed.

Controlling thermal radiation has recently emerged as an attractive strategy to save building energy for personal thermal management because it can produce a localized cooling or warming effect to the human body without any energy consumption. This approach is based on the fact that human skin at the temperature around 33° C. has the innate ability (emissivity 8=0.98) to emit thermal radiation in the mid-infrared region with the peak intensity at the wavelength of 9.5 μm, which accounts for more than 50% of body heat dissipation in indoor environments. By manipulating the ways in which textiles interact with the infrared radiation emitted from the human body, passive radiative cooling or heating effects can be achieved. For example, radiative heating takes place when the textiles block the infrared radiation from the skin to the ambient environment.

Manipulating the thermal radiation emitted from the human body in military equipment plays a vital role in thermal camouflage applications. Thermal camouflage involves matching the infrared emission intensity of objects with the surroundings, which has gained increasing attention with the advancement of infrared imaging technology.

For the purpose of suppressing radiative heat emission, metallic coatings are typically utilized owing to their high reflectance and low emissivity in the infrared wavelength region. However, metallic surfaces also show high reflectance over the entire solar spectrum, which can restrain their practical utility in both personal thermal management and thermal camouflage applications. For instance, the radiative heating performance during daytime is compromised as the previously reported metal-based textiles reflect all the sunlight rather than absorbing it to reach additional heating power from the renewable solar energy. In addition, due to the high reflectance of metals in the visible spectral range, the coloration of radiative heating textiles remains challenging. Furthermore, metallic coatings in the bulk states could lead to strong reflection of visible features in daytime. This makes it difficult to integrate thermal camouflage with visual camouflage on the same object, which is needed to avoid both daytime and nighttime surveillance for all-day cloaking. Therefore, it is imperative to develop infrared reflectors with selective control over visible optical properties to address these major issues in both personal thermal management and thermal camouflage.

### BRIEF DESCRIPTION OF THE DRAWINGS

FIG. 1A displays a schematic of visibly transparent and infrared reflective coatings (VTIR) to block emission of thermal radiation for radiative heating and thermal camouflage.

FIG. 1B displays a schematic of fabrication process and SEM images for VTIR coatings, wherein the scale bar is 2 μm.

FIG. 2A displays a characterization of infrared reflectance, FIG. 2B displays a characterization of infrared emissivity and FIG. 2C displays a characterization of visible transmittance for metal nano-mesh patterns with different hole sizes. FIG. 2D displays a characterization of infrared reflectance, FIG. 2E displays a characterization of infrared emissivity and FIG. 2F displays a characterization of visible transmittance spectra for metal nano-mesh patterns with different coating thicknesses.

FIG. 2G displays a schematic of radiative heating performance measurement set-up.

FIG. 3A displays a UV-VIS transmittance spectra of single-layer metal nano-mesh, plain oxide/metal/oxide thin film (OMO), and nano-mesh pattern with OMO tri-layer structure (nano-mesh_OMO). FIG. 3B displays a photograph of nano-mesh_OMO. FIG. 3C displays a FTIR characterization of infrared reflectance and emissivity of nano-mesh_OMO, wherein the gray area indicates the blackbody radiation at human skin temperature of 34° C. FIG. 3D displays measured artificial skin temperature for bare skin and skin covered with cotton, nano-mesh_OMO, and Mylar film. The data shows mean±SD of temperature at steady state.

FIG. 4A displays a schematic of VTIR/rGO for passive heating in outdoor conditions by combining radiative heating and photothermal effects and FIG. 4B displays a photograph of VTIR/rGO for passive heating in outdoor conditions by combining radiative heating and photothermal effects. FIG. 4C displays a UV-VIS spectra of VTIR/rGO sample and FIG. 4D displays a FTIR spectra of VTIR/rGO sample. FIG. 4E displays a photograph of an experimental setup for testing the outdoor heating performance (inset shows the sunlight). FIG. 4F displays a real-time temperature measurement of bare artificial skin and artificial skin covered with VTIR/rGO, cotton and Mylar film to evaluate the outdoor heating performance on a sunny winter day in Urbana, Illinois (average wind speed ˜12 KPH). Ambient temperature and solar radiation intensity are plotted for reference.

FIGS. 5A-F display a photograph and thermal image comparison between FIG. 5A—colored textiles and FIGS. 5B-5D—colored textiles laminated with VTIR coatings. FIG. 5E displays a photograph and thermal image of a visible camouflage textile combined with VTIR coatings. FIG. 5F displays a thermal images of samples with and without VTIR coatings under different temperature conditions. Dotted squares indicate the locations of samples without VTIR coatings.

FIG. 6 displays a visibly transparent infrared reflective coating for personal thermal management and thermal camouflage was introduced using a tri-layer nanophotonic structure. By transmitting visible light and reflecting infrared emission, the structure not only enables 6.6° C.-15° C. passive heating for both indoor and outdoor conditions, but also allows for integration of thermal and visible camouflage capabilities for both daytime and nighttime cloaking.

### Metal Coating Ratio Calculation:

The metal coverage area ratio was calculated as follows using a repeated portion of the nano-mesh patterned coating

$$Coverage area ratio ( \% ) = \frac{Metal coverage area}{Total area} * 100$$

TABLE 1

| Hole size | Metal coating ratio (%) | Hole area ratio (%) |
|---|---|---|
| 880 nm | 29.8 | 70.2 |
| 820 nm | 39.1 | 60.9 |
| 760 nm | 47.7 | 52.3 |

FIG. 7 displays an SEM image of hexagonally packed PS sphere over large area.

FIG. 8 displays an FTIR reflectance spectrum of bare PET substrate in mid-infrared region.

FIGS. 9A-B display an FTIR transmittance spectra of metal nano-mesh samples with different hole sizes (FIG. 9A), and coating thicknesses (FIG. 9B).

FIG. 10A displays a characterization of an UV-VIS transmittance of Ag-(black) and Cu-(red) based metal nano-mesh coatings and FIG. 10B displays a characterization of an FTIR reflectance of Ag-(black) and Cu-(red) based metal nano-mesh coatings.

FIG. 11 displays a characterization of visible transmittance comparison between FDTD simulation and experimental results for plain thin film of OMO tri-layer structure.

FIG. 12A displays an SEM image of nano-mesh_OMO coatings and FIG. 12B displays an AFM characterization of nano-mesh_OMO coatings.

FIG. 13 displays a characterization of a haze comparison between single-layer metal nano-mesh (black) and nano-mesh_OMO coatings (red).

FIG. 14A displays an FTIR measurement of infrared reflectance of normal cotton (red) textile and Mylar film (black) and FIG. 14B displays an FTIR measurement of infrared emissivity for normal cotton (red) textile and Mylar film (black).

FIG. 15A displays an SEM image and FIG. 15B displays a breathability comparison of the VTIR coating on nanoporous PET and the cotton textile.

FIG. 16 displays a comparison of tensile strength for cotton, Mylar blanket and nano-mesh_OMO.

FIG. 17A displays a digital image of a bending test and FIG. 17B displays a comparison of passive radiative heating performance of nano-mesh_OMO before and after the bending tests. The data shows mean±standard deviation (SD) of temperatures at steady state.

FIG. 18 displays a comparison of passive radiative heating performance of nano-mesh_OMO before and after washing tests. The data shows mean±SD of temperatures at steady state.

FIG. 19 displays SEM images of remaining PS beads after the first and second lift-off process.

### DETAILED DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

As used herein, the term “Infrared emissivity” generally refers to infrared emissivity calculated by 100%-reflectance-transmittance.

As used herein, the term “oxide”, refers to an oxide compound e.g., TiO₂, ZnO, etc.

As used herein, the term “sheet like substrate” refers to a material deposited or arranged in laterally extending or horizontal layers resembling a sheet. For example, a film (such as a polymeric film), or a textile (e.g., woven textile, non-woven, knitted, etc.).

As used herein, the term “mesh structure” refers to a selective barrier to the passage of radiation or matter. In some embodiments, the mesh structure may be a nano mesh comprising a plurality of nanoscale pore arrays whose pore size is large enough for the visible light to pass through, while being small enough to block infrared radiation. In some embodiments, the interconnected nano-mesh structure provides a high mid-infrared reflectance of at least 40%.

As used herein, the term “patterned first layer” as used herein refers to layer that is arranged in a pattern that is discontinuous or intermittent, etc.

As used herein, the term “coated” as it relates to the use of the term “coated article” refers to incorporation of the VTIR coating into an article (e.g., textile, textile mesh, tarpaulin etc.), disclosed herein.

As used herein, the term “thermally obscure” refers to preventing or reducing the detection of a subject or object by a device that contains a sensor or other component that translates infrared (IR) radiation generated by heat into a visual image showing the temperature variation of a surface (e.g., a thermal or thermographic camera).

The inventors have developed a visibly transparent, IR-reflective (VTIR) coating suitable for application to articles, such as textiles. This coating allows for passive heat (IR) management in two modes: (1) indoor heating by blocking the infrared transmission toward the environment, and (2) outdoor heating by combining radiative heating and photothermal effects.

The optical transparency of this metallic, nanostructured layer confers unprecedented flexibility in the aesthetic and useful visual properties (e.g., fluorescent safety colors, camouflage colors/patterns) of materials. Applications include high-performance, reversible clothing; IR-resistant, camouflaged tarpaulins for military equipment and facilities; and IR-resistant uniforms and tactical gear.

Nanotextiles for the apparel industry use a variety of nanomaterials to achieve high-tech fabrics for regular clothing, sports apparel, and uniforms.

Common features are waterproof, stain-resistance, ultraviolet (UV) radiation protection, moisture absorption, fireproof, chemical resistance, heat insulation, and odor prevention.

One aspect of the invention pertains to article (e.g., a textile) comprising a single-layer, transparent metal mesh as disclosed herein. In some embodiments, the mesh blocks IR but is transparent to visible light when pore diameter is 760 nm and mesh thickness is about 18 nm.

A further aspect of the invention pertains to article (e.g., a textile) comprising a multilayer, transparent metal mesh as disclosed herein. In some embodiments, the multilayer mesh blocks IR but is transparent to visible light when pore diameter is 760 nm and mesh thickness is about 18 nm-42 nm.

Transparency to visible light gives the coating or textile of the invention additional functionalities such as for cloaking, camouflage, or aesthetics.

The VTIR coating of the invention may be applied to any layer of the article without compromising the color of the article.

The novel infrared reflectors disclosed herein may be configured to provide selective control over visible optical properties. One aspect of the invention pertains to a visibly transparent infrared reflector (VTIR) to suppress the emission of infrared radiation for personal thermal management and thermal camouflage while enabling independent control over optical properties in the visible spectral region. The VTIR coating may be comprised of a nano-mesh patterning strategy combined with an oxide/metal/oxide (OMO) trilayer structure.

In some embodiments, the hole size and coating thickness of VTIR may be adjusted to achieve high reflectance of >80% in the mid infrared region and high visible transmittance of >80% at 550 nm. In further embodiments, the VTIR may provide 6.6° C. radiative heating effects in indoor conditions without sacrificing breathability and coloration.

One aspect of the invention pertains to a method comprising combining a VTIR with reduced graphene oxide (rGO) layers to e.g., to enable thermal comfort for human body at freezing temperatures in outdoor conditions.

Another aspect of the invention pertains to a method comprising creating a thermal camouflage effect of VTIR at different temperatures from 34° C. to 250° C., which can be integrated with visual camouflage patterns to satisfy both daytime and nighttime camouflaging demands.

A further aspect of the invention pertains to a nano-mesh pattern design/structure for the VTIR coating. This coating may comprise a plurality of nanoscale pore arrays whose pore size is large enough for the visible light to pass through, while being small enough to block infrared radiation. In some embodiments, the interconnected nano-mesh structure provides a high mid-infrared reflectance of at least about 40%. It is envisioned that a nano-mesh structure may be fabricated and their pore size and thickness modified to obtain metallic coatings with simultaneously high infrared reflectance and high visible transmittance.

An exemplary fabrication process for the nano-mesh coatings may include: a first step including depositing a monolayer (of e.g., 1 μm diameter) polystyrene (PS) beads (e.g., hexagonally) close-packed such as by water-air assembly; and transferring to a polyethylene terephthalate (PET) substrate. The monolayer assembly of PS beads may be uniform over a large area. In a second step, the diameter of PS beads can be reduced to the desired size by e.g., reactive ion etching (RIE). Next, the etched PS bead assembly may be used as the mask for metal deposition by e-beam evaporation. Finally, after the metal deposition, the PS beads can be lifted off (e.g., via through tape and sonication in a solvent such as ethanol) to obtain a metallic nano-mesh pattern on the substrate.

In some embodiments, gold (Au) may be used as a model material for the metal deposition layer owing to its stability and compatibility with various applications. For example, the present disclosure illustrates the infrared properties of nano-mesh structures as a function of hole size measured by Fourier-transform infrared spectroscopy (FTIR) coupled with a gold integrating sphere.

In some aspects of the invention, the hole size may be varied between values of 880 nm, 820 nm, and 760 nm by (e.g., controlling the RIE etching time, while the coating thickness was fixed at e.g., 18 nm. In some embodiments having different hole sizes, all infrared reflectance spectra show an increasing trend as the wavelength increases, with small peaks detected around 8˜9 μm which correspond to the stretching of C═O groups of the PET substrate. In other embodiments, as the hole size decreases, the overall infrared reflectance of nano mesh coatings increases, indicating that the mid-infrared wavelength has more difficulty penetrating smaller holes in the nanoscale. In some embodiments, infrared transmittance does not change significantly with the hole size.

Moreover, in addition to gold, other metal materials such as silver (Ag) and copper (Cu) may be used. In the same conditions (760 nm hole size, 18 nm coating thickness), both silver and copper-based nano-mesh samples showed high infrared reflectance over 75% at the wavelength of 9.5 μm and decent visible transmittance around 60% at the wavelength of 550 nm, confirming the versatile material choices of nano mesh design.

In some embodiments, the skin temperature increases as the hole size decreases and the coating thickness increases, comporting with higher infrared reflectivity and lower infrared emissivity, a higher radiative heating performance may be achieved. It is envisioned that, as a result of the radiative heating performance of nano-mesh being easily controlled by adjusting the hole size and coating thickness, the nano-mesh based textiles could be applied in various weather conditions without significantly changing the thicknesses of cloth.

While the nano-mesh coatings with a single metal layer can achieve high infrared reflectance by tuning the hole size and coating thickness, their visible transmittance was still not sufficiently high due to the trade-off between infrared reflectance and visible transmittance. An embodiment, configured to further increase the visible transmittance without compromising the radiative heating performance, includes an OMO tri-layer structure (i.e., TiO2/Au/TiO2) operably configured and combined with the nano-mesh pattern design. In contrast to a single metal layer, each layer in the OMO structure causes destructive interference of the reflective lights and consequently increases transmittance in the visible region. In some embodiments, thickness of OMO tri-layer structure was optimized at 12 nm/18 nm/12 nm to maximize the visible transmittance at 550 nm.

In an embodiment with the nano-mesh pattern comprising a 12 nm/18 nm/12 nm OMO tri-layer coating (nano-mesh-OMO), a hole size was set at 760 nm which showed the highest infrared reflectance among different hole sizes. In some embodiments, it is confirmed by the AFM and SEM images that the hole arrays with a thickness of about 42 nm was uniformly deposited over a large area. As disclosed herein, with the combination of OMO tri-layer structure and nano-mesh pattern, the visible transmittance was increased to a higher value of 80.4% (average: 74.1%) at 550 nm. In other embodiments, the single-layer metal nano-mesh (hole size of 760 nm and coatings thickness of 18 nm) and plain thin-film OMO (12 nm/18 nm/12 nm) samples showed much lower visible transmittances of 65.3% (average: 61.1%) and 70.2% (average: 57.0%), respectively.

In some embodiments, the haze in the visible region was also improved by introducing the oxide layers for nano-mesh-OMO, as compared to the single-layer metal nano-mesh.

In some embodiments, the first oxide layer acts as a sacrificial layer and reduces the surface roughness prior to metal deposition. This enables nano-mesh_OMO to show less scattering than single-layer metal nano-mesh, resulting in haze decrement. The present disclosure shows an embodiment of the nano mesh OMO sample, exhibiting good transparency to illustrate clear school logos underneath.

Due to the high infrared transmittance of ultrathin oxide layers, nano-mesh_OMO displayed high reflectance of >80% and low emissivity of <20% in the mid-infrared region, comparable to that of single-layer metal nano-mesh coatings.

In some embodiments made of nano-mesh OMO coatings, radiative heating effects of 6.6° C., which was 3.8° C. higher than that of commercial cotton and comparable to that of Mylar blanket were observed. These thermal performance results are consistent with their infrared emissivity difference as disclosed herein.

In some embodiments, the VTIR coating sample exhibits a water transmission rate of 0.0185 g·cm−1h−1 which is comparable to that of cotton (0.0214 g·cm−1h−1). In such embodiments, the nanopores of PET are small and sparse enough not to affect the pattern of VTIR coating.

Additionally, bending and washing tests were conducted to examine the mechanical stability of some embodiments of VTIR coatings. The embodiments showed a negligible difference in the passive radiative heating performance before and after the mechanical tests, indicating their suitability for wearable applications. This good mechanical stability comes from 1) flexibility of nano-mesh structure, 2) strong adhesion of OMO structure with the substrate, and 3) ductility of the metal layer.

Next, to demonstrate the use of nano-mesh_OMO based VTIR coatings for daytime outdoor heating applications, an embodiment having a laminated VTIR with rGO layer on the back (denoted as VTIR/rGO thereafter). The VTIR layer of said embodiment on the front will not only block the radiative heat loss from the skin to the environment, but also allow the transmission of solar light which can be subsequently absorbed by the rGO layer on the back and converted to thermal energy to warm up the human body. The present disclosure exhibits the dark black color of VTIR/rGO sample.

An exemplary embodiment having UV-VIS characterization showed that VTIR/rGO can absorb more than 80% of solar energy in the visible wavelength region. The infrared reflectance of VTIR/rGO measured by FTIR remained a high value of about 80% in the mid-infrared region. Furthermore, thermal measurements in the daytime outdoor environment under direct sunlight demonstrated that the VTIR/rGO sample can maintain the skin temperature around 33° C. in cold weathers with low ambient temperatures around 0° C. and strong wind levels.

In some embodiments colored textiles with VTIR coatings showed the same colors of black, red and blue as normal cotton textiles. In the thermal images taken by an infrared camera of certain embodiments, the skin area covered by normal colored cotton samples displayed a warm red color, indicating strong emission of thermal radiation similar to that of bare skin. In some embodiments, the skin area covered by colored cotton with VTIR coatings displayed a dark purple color, signifying a much lower emission of human body heat radiation. The comparison of certain embodiments by thermal imaging clearly shows that VTIR coatings can block human body thermal radiation for personal thermal management while fully retaining the color of normal textiles.

In some embodiments, due to the high visible transmittance of VTIR coatings, the visual camouflage pattern is still revealed, preserving its day-time cloaking functionality. In addition, as shown in the thermal imaging, VTIR coatings can minimize the emission of thermal radiation from the surface at the skin temperature of 34° C. to the level comparable with that of the surrounding environment, allowing for night-time cloaking under an infrared detecting camera.

In some embodiments having VTIR coatings, such embodiments achieved excellent thermal camouflage effects under various temperature conditions (100° C.-250° C.) by drastically reducing the thermal radiation for high-temperature objects This indicates that the VTIR coatings could enable all-day camouflage on a variety of military objects, from military uniforms to vehicles, under various temperature environments.

### Examples

The following examples are provided solely to illustrate the present invention and are not intended to limit the scope of the invention, described herein.

### Example 1

Method of Fabrication (of an exemplary embodiment). PS beads (Carboxyl Latex Beads, 4% w/v, 1 μm, THERMO FISHER) were washed through a centrifuge three times at 4000 rpm for 10 minutes each, and then dispersed in ethanol and DI water at a ratio of 1:1. The water-air assembly was performed with a syringe pump by injecting the solution at a constant rate. A petri dish was filled with DI water and the syringe needle was placed halfway in the water. The PS bead solution was injected at a constant speed (10-30 μl/min), and the pump was turned off when a monolayer fully formed in the petri dish. The cleaned substrate was put under the monolayer and scooped carefully to not break the monolayer. The substrate was dried in a 3D printed sample holder at a 45-degree angle, which facilitated the formation of a close, hexagonally packed monolayer. The fully dried PS beads were shrunk in size through RIE using 02 gas (60 W 50 SCCM). Next, for single-layer metal nano-mesh samples, Cr and metal were deposited through an e-beam evaporator. Cr was used to increase the adhesion between the metal and substrate. In the case of the nano-mesh_OMO samples, the metal and oxide layers were deposited through e-beam evaporation and sputtering, respectively. The thickness of OMO structure is optimized as 12 nm/18 nm/12 nm for TiO2/Au/TiO2 and 30 nm/18 nm/30 nm for TiO2/Ag/TiO2. The deposition rate was confirmed by a quartz crystal microbalance monitor system that was calibrated through X-ray reflectometry. Cr, metal, and oxide layers were deposited at deposition rates of 0.5, 1.0, and 0.1 Å/s, respectively. After deposition, the beads were lifted off using 3M magic tape, followed by sonication in ethanol. The lift-off process was repeated twice to fully removed the PS beads (FIG. 19).

Thermal measurement: Radiative heating measurements were performed with an artificial human skin. The human skin was simulated by a silicone rubber flexible heater (1.55 Watts/cm2, Omega Engineering) connected to a power supply (Keithley 2260). Two self-adhesive surface thermocouples (K-type, Omega Engineering) were attached to the top and bottom of the artificial skin. The artificial skin was placed on top of a guard heater and an insulating foam which helped the heat generated by the artificial skin only transfer upwards to the ambient surroundings. The guard heater was supplied with heat through the power supply (Keithley 3630), so that the upper and lower thermocouples could always shows the same temperature. This prevented heat conduction downwards to the table. For indoor testing, the entire measuring system was placed in a chamber at the room temperature of 25° C. For outdoor testing, the measurement setup was placed in the outside exposed to the sky. After artificial skin was covered by the sample, the stabilized skin temperature response was recorded accordingly. Bared skin case without any sample coverage was also measured as a control sample.

Washing Test: The samples were washed in 100 mL water with 3 mL detergent under stirring at the speed of 400 rpm. 1 cycle of washing test was 30 minutes, and tests were performed for 25 hours for 50 washing tests.

Tensile Test: The tensile testing was performed by universal testing machine (Model 43, MTS Criterion) with a displacement rate of 10 mm min−1. The sample size was 1 cm wide with 3 cm long.

Water vapor transmission rate test: For this test, nanoporous PET (0.4 μm PET Membrane Filter, STERLITECH) was used as substrates. A vial filled with distilled water was sealed with samples using an open-top cap and O-ring. The vial was placed in a chamber at 34° C. The vial weight was measured periodically, and the water transmission rate was calculated by dividing the reduced weight by the area of the open-top cap.

FDTD Numerical Simulation: Finite-difference time-domain method (FDTD solutions, LUMERICAL) was used to calculate the transmittance of plain thin-film OMO tri-layer structures. PET was used as the substrate and the width and length of all layers were fixed at 8 μm. Anti-symmetric boundary conditions in the x-axis (transverse direction) and symmetric boundary conditions in the y-axis (longitudinal direction) were applied in the calculation. For the z-axis (vertical direction), Perfect Matching Layer (PML) boundary conditions were used. The simulated transmittance spectra were obtained in the wavelength range of 400-800 nm using a normal plane wave and 1D line monitors. The refractive index (n) and extinction coefficient (k) of each material (i.e., TiO2, Au, Ag and Cr) were obtained from literature. [42-44]

Material characterization: The visible and infrared optical properties were measured by UV-VIS spectrometry (Agilent Cary 5000) and FT-IR spectrometry (Thermo Nicolet Nexus 670), respectively. Each spectrometer was accompanied with an integrating sphere. The visible region absorbance and infrared emissivity was calculated by the following equation.

$$Haze = \frac{Foward scattered transmittance}{Total transmittance} \qquad ( 2 )$$

Haze was calculated by the equation below.

$$Absorbance / emissivity ( \% ) = 100 \% - transmittance ( \% ) - reflectance ( \% ) \qquad ( 1 )$$

Here, total transmittance was measured with an integrating sphere and forward scattered transmittance was calculated by subtracting normal incident light from the total transmittance. Normal incident light was measured with the same UV-VIS spectrometer without the integrating sphere. Average transmittance was calculated by weight average with standard solar spectra (ASTM G-173). The film structure was characterized using a scanning electron microscope (SEM, HitachiS-4800) and atomic force microscope (AFM, Asylum Research Cypher). Thermal images were taken by a thermal imaging camera (Ti 110, Fluke).

Statistical Analysis: The data shows mean±SD of 100 consecutively measured values of temperature at steady state.

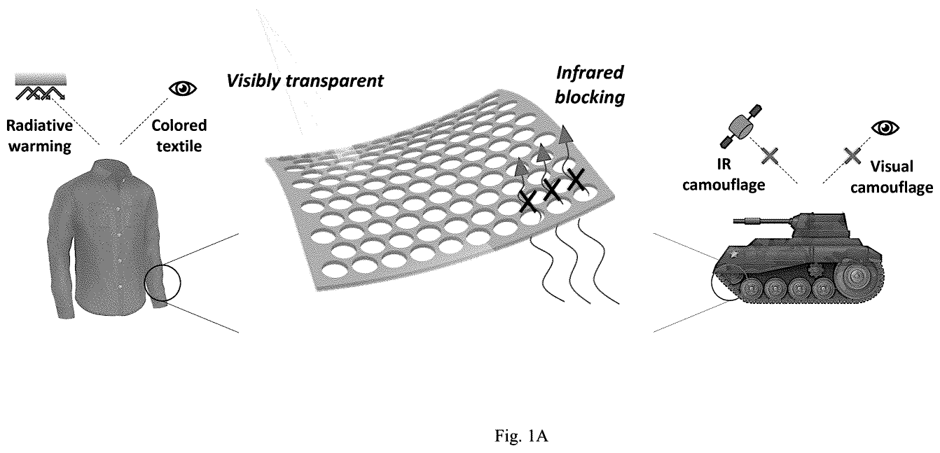

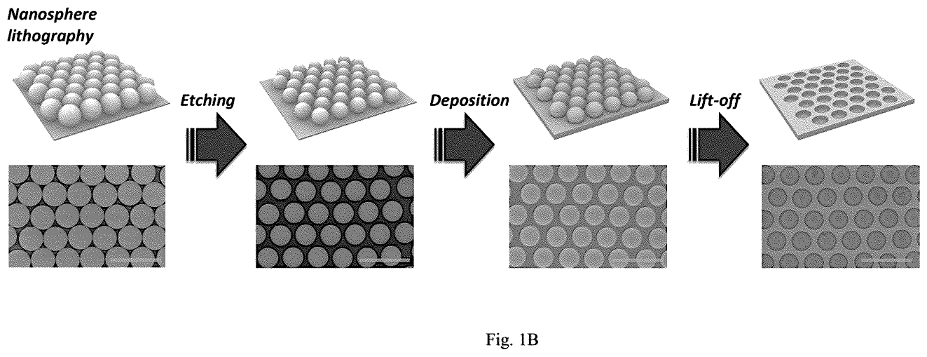

Results and Discussion: An exemplary nano-mesh pattern design for the VTIR coating is depicted in FIG. 1A. It consists of nanoscale pore arrays whose pore size is large enough for the visible light to pass through, while being small enough to block infrared radiation. This design is an advancement over the previous study which used rigorous coupled-wave analysis to simulate the reflectance of nanostructured metallic films in the mid-infrared regions. The simulation results illustrated that the interconnected nano-mesh structure gives a high mid-infrared reflectance approaching 100%, whereas the isolated nano-dot pattern with the same areal coverage density shows much lower mid-infrared reflectance. Herein, experimental fabrication of the nano-mesh structures and further tuning of their pore size and thickness to realize metallic coatings with simultaneously high infrared reflectance and high visible transmittance was done for the first time. The fabrication process for the nano-mesh coatings is displayed in FIG. 1B. First, a monolayer of 1 μm diameter polystyrene (PS) beads was hexagonally close-packed by water-air assembly and transferred to the polyethylene terephthalate (PET) substrate. The scanning electron microscope (SEM) image in FIG. 7 shows that the monolayer assembly of PS beads is uniform over a large area. In the second step, the diameter of PS beads was reduced to the desired size by reactive ion etching (RIE). Next, the etched PS bead assembly was used as the mask for metal deposition by e-beam evaporation. Finally, after the metal deposition, the PS beads were carefully lifted off through tape and sonication in ethanol, leading to the formation of metallic nano-mesh pattern on the substrate.

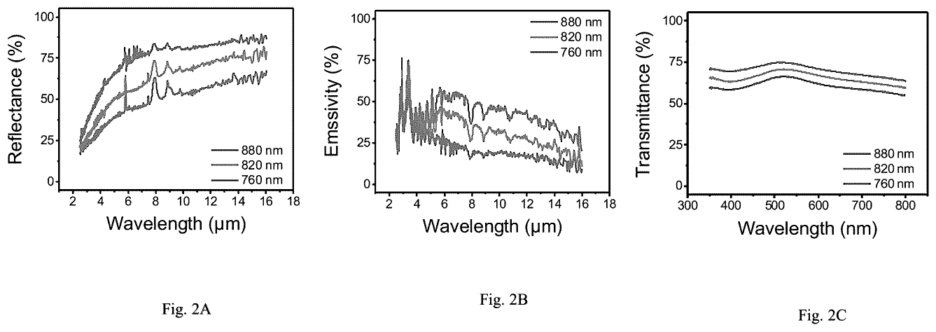

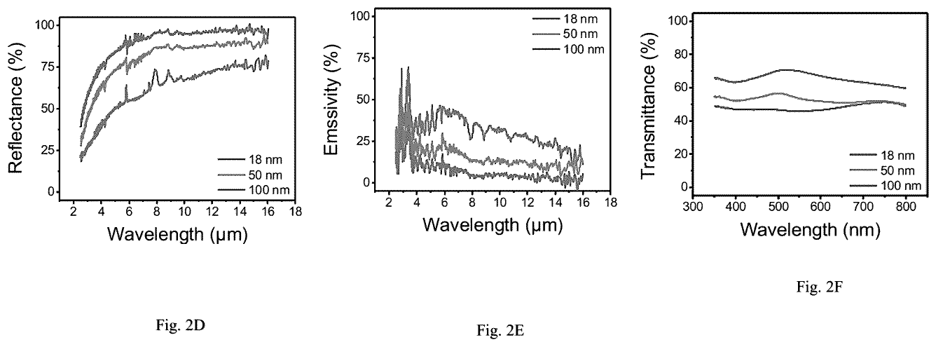

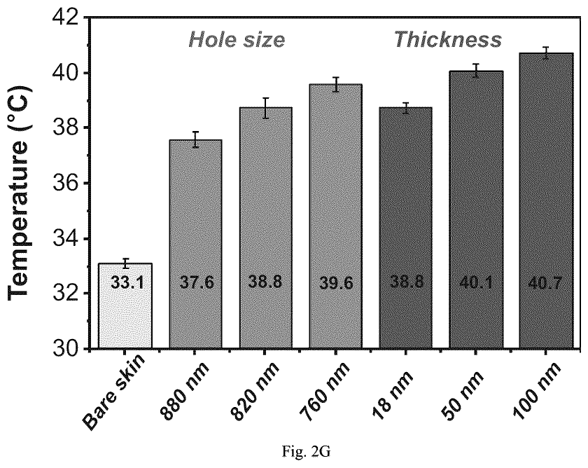

In order to optimize the infrared reflectance and visible transmittance of nano-mesh coatings, further investigation of the effects of hole size and coating thickness was done. Gold was chosen as a model material for the metal deposition layer owing to its stability with the surrounding environment and compatibility with various applications. FIGS. 2A and B show the infrared properties of nano-mesh structures as a function of hole size measured by Fourier-transform infrared spectroscopy (FTIR) coupled with a gold integrating sphere. The hole size was varied at the values of 880 nm, 820 nm, and 760 nm by controlling the RIE etching time, while the coating thickness was fixed at 18 nm. For different hole sizes, all their infrared reflectance spectra show an increasing trend as the wavelength increases (FIG. 2A), with small peaks detected around 8˜9 μm which correspond to the stretching of C═O groups of the PET substrate (FIG. 8). Without wishing to be limited by any particular theory, as the hole size decreases, the overall infrared reflectance of nano-mesh coatings increases, indicating that the mid-infrared wavelength has more difficulty penetrating smaller holes in the nanoscale. FTIR spectra in FIG. 9A show that their infrared transmittance does not change significantly with the hole size. Correspondingly, their infrared emissivity (calculated by 100%-reflectance-transmittance) decreases as the hole size increases (FIG. 2B). At the hole size of 760 nm, high reflectance of over 80% and low emittance of 18% were achieved at the wavelength of 9.5 μm. It should be noted that the nano-mesh pattern with the hole size of 760 nm only covers 48% of the substrate surface with metal coatings (see Supplementary Information for details), while the remaining 52% surface area is exposed by the hole arrays. Without wishing to be limited by any particular theory, these results confirm that the high infrared reflectance of over 80% arises from the unique nanophotonic effect of the interconnected nano-mesh pattern, which is much larger than the areal coverage percentage of metal coatings. Furthermore, the transmittance of metal nano-mesh coatings in the visible light region was measured by ultraviolet-visible (UV-VIS) spectroscopy. As shown in FIG. 2C, the UV-VIS spectra of metal nano-mesh coatings are peaked around 550 nm, which comes from d-t intra-band transition. As the hole size becomes smaller, their overall visible transmittance slightly decreases, reaching the value of 65.3% at the wavelength of 550 nm (average: 61.1%) for the hole size of 760 nm.

To investigate the effect of coating thickness, the infrared and visible properties were evaluated for the nano-mesh samples with different thicknesses of 18, 50, and 100 nm, while their hole size was fixed at 820 nm. FTIR measurements showed that the infrared reflectance of nano-mesh coatings increased, and their infrared emissivity decreased, as the thickness was increased (FIGS. 2D and E). There was no significant difference in their infrared transmittance with varying thickness (FIG. 9B). The 100 nm-thick sample exhibited the highest reflectance of over 90% and the lowest emissivity of less than 10% in the infrared wavelength range of 7 to 14 μm. On the other hand, UV-VIS spectra in FIG. 2F illustrate that thicker metal nano-mesh layer decreases their visible transmittance, with the 100 nm-thick sample showing the lowest value of 45.9% (average: 47.7%) and the 18 nm-thick sample showing the highest value of 69.8% (average: 65.8%) at the wavelength of 550 nm. Moreover, in addition to gold, other metal materials such as silver and copper were investigated. In the same conditions (760 nm hole size, 18 nm coating thickness), both silver and copper-based nano-mesh samples showed high infrared reflectance over 75% at the wavelength of 9.5 μm and decent visible transmittance around 60% at the wavelength of 550 nm, confirming the versatile material choices of nano-mesh design (FIGS. 10A-10B).

Next, evaluation of the radiative heating performance of metal nano-mesh coatings for indoor conditions at the room temperature of 24° C. using the measurement set-up shown in FIG. 2G was done. A flexible rubber heater was used to simulate the human skin. After the rubber heater was covered with different samples, the resulting skin temperatures were recorded and compared with the bare skin case (See details in experimental section). All the nano-mesh samples showed noticeable warming effects, enabling the skin temperature to increase by 4.5° C. to 7.6° C., compared to that of bare skin. Without wishing to be limited by any particular theory, it can also be found that the skin temperature increases as the hole size decreases and the coating thickness increases. These results seem to be consistent with the common understanding that higher infrared reflectivity and lower infrared emissivity lead to higher radiative heating performance. In addition, since the radiative heating performance of nano-mesh may be easily controlled by adjusting the hole size and coating thickness, the nano-mesh based textiles may be applied in various weather conditions without significantly changing the thicknesses of cloth.

While the nano-mesh coatings with a single metal layer can achieve high infrared reflectance by tuning the hole size and coating thickness, their visible transmittance was still not sufficiently high due to the trade-off between infrared reflectance and visible transmittance. To further increase the visible transmittance without compromising the radiative heating performance, an OMO tri-layer structure (i.e., TiO2/Au/TiO2) was implemented to combine with the nano-mesh pattern design. Compared to a single metal layer, each layer in the OMO structure causes destructive interference of the reflective lights and consequently increases transmittance in the visible region. [32,33] Using finite-difference time-domain (FDTD) simulation (See details in experimental section), the thickness of OMO tri-layer structure was optimized at 12 nm/18 nm/12 nm to maximize the visible transmittance at 550 nm (FIG. 11). Experimental UV-VIS measurement of the plain thin-film OMO sample matched with the simulation result, exhibiting a maximum peak around 550 nm. Without wishing to be limited by any particular theory, the small difference between simulation and experiment stemmed from the surface roughness which may cause light scattering and a slight optical constant difference from literature. [34,35]

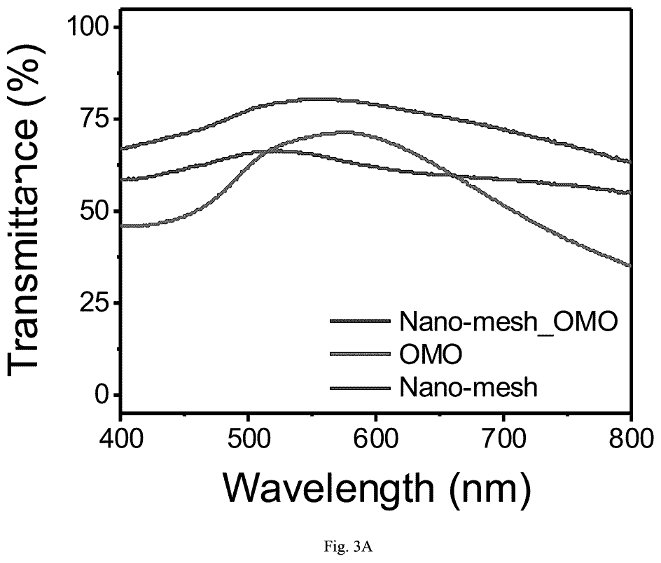

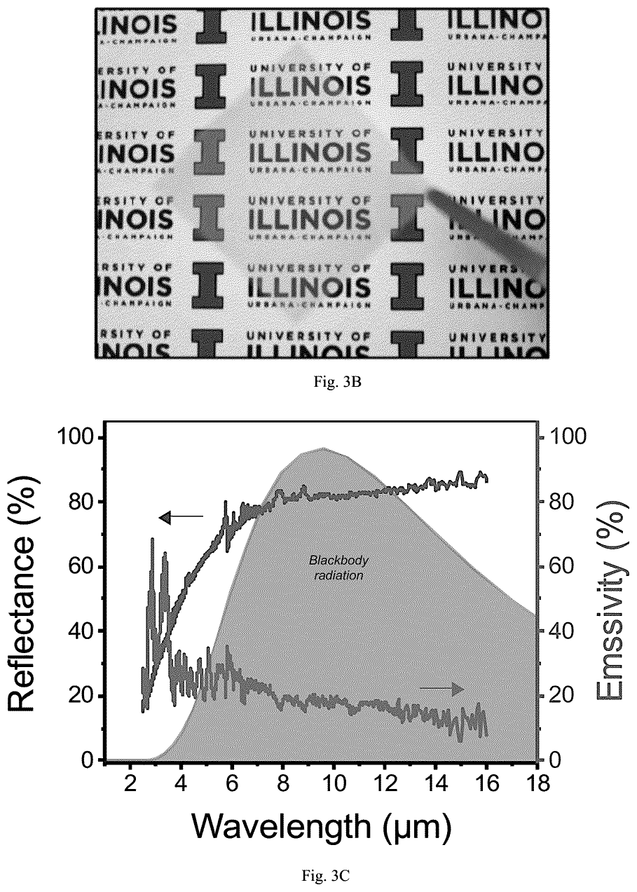

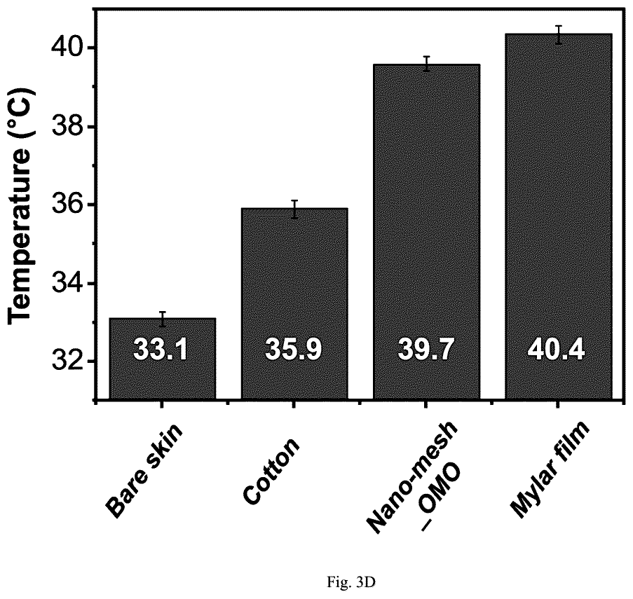

For the nano-mesh pattern with 12 nm/18 nm/12 nm OMO tri-layer coating (nano-mesh_OMO), its hole size was set at 760 nm which showed the highest infrared reflectance among different hole sizes. It was confirmed by the AFM and SEM images that the hole arrays with a thickness of about 42 nm was uniformly deposited over a large area (FIGS. 12A-12B). As shown in FIG. 3A, with the combination of OMO tri-layer structure and nano-mesh pattern, the visible transmittance was increased to a higher value of 80.4% (average: 74.1%) at 550 nm. In comparison, the single-layer metal nano-mesh (hole size of 760 nm and coatings thickness of 18 nm) and plain thin-film OMO (12 nm/18 nm/12 nm) samples showed much lower visible transmittances of 65.3% (average: 61.1%) and 70.2% (average: 57.0%), respectively. It should be mentioned that the haze in the visible region was also improved by introducing the oxide layers for nano-mesh_OMO, as compared to the single-layer metal nano-mesh (FIG. 13). The first oxide layer acts as a sacrificial layer and reduces the surface roughness prior to metal deposition. Without wishing to be limited by any particular theory, this enables nano-mesh_OMO to show less scattering than single-layer metal nano-mesh, resulting in haze decrement. FIG. 3B shows a photograph of the nano-mesh_OMO sample, exhibiting good transparency to illustrate clear school logos underneath. Due to the high infrared transmittance of ultrathin oxide layers, nano-mesh_OMO displayed high reflectance of >80% and low emissivity of <20% in the mid-infrared region, comparable to that of single-layer metal nano-mesh coatings (FIG. 3C). The thermal measurements at indoor conditions demonstrated that the VTIR sample made of nano-mesh OMO coatings can enable radiative heating effect by 6.6° C., which was 3.8° C. higher than that of commercial cotton and comparable to that of Mylar blanket (FIG. 3D). Without wishing to be limited by any particular theory, these thermal performance results are consistent with their infrared emissivity difference shown in FIGS. 14A-14B. Next, the wearability of nano-mesh_OMO based VTIR samples was evaluated. For the water transmission test, nanoporous PET is used as a substrate. The VTIR coating sample exhibits a water transmission rate of 0.0185 g·cm−1h−1 which is comparable to that of cotton (0.0214 g·cm−1h−1). The nanopore of PET is small and sparse enough not to affect the pattern of VTIR coating (FIGS. 15A-15B). Notably, Mylar blankets shows no breathability because the whole surface is coated with aluminum, whereas the hole arrays of VTIR are much larger than water molecules to allow for sufficient breathability and good wearability. VTIR coatings can endure ˜90 N of tensile force with similar elongation of Mylar blankets (FIG. 16). Additionally, bending and washing tests were conducted to examine the mechanical stability of VTIR coatings (FIGS. 17A-17B and 18). The sample showed a negligible difference in the passive radiative heating performance before and after the mechanical tests, indicating their suitability for wearable applications. Without wishing to be limited by any particular theory, this good mechanical stability comes from 1) flexibility of nano-mesh structure, 2) strong adhesion of OMO structure with the substrate, and 3) ductility of the metal layer. [38-40]

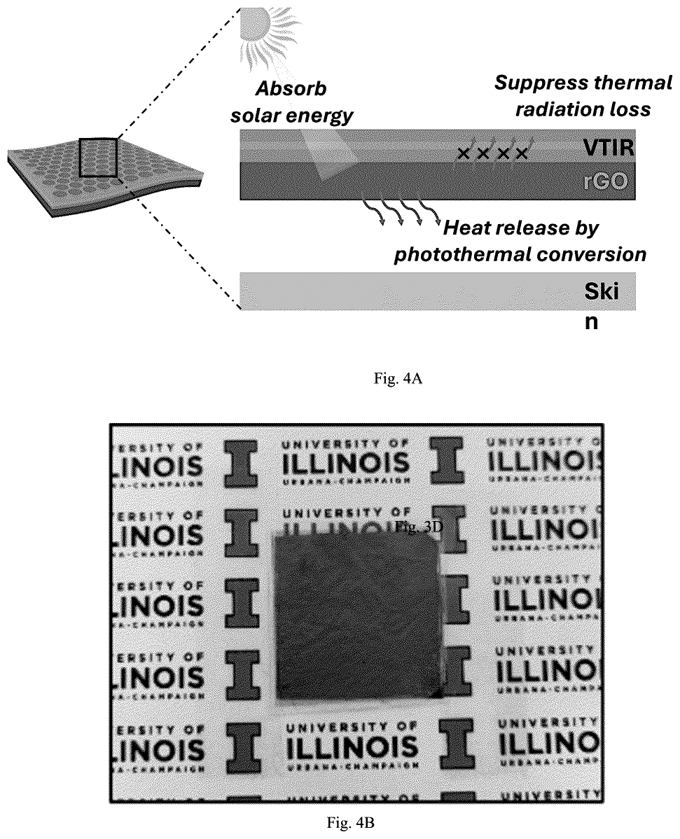

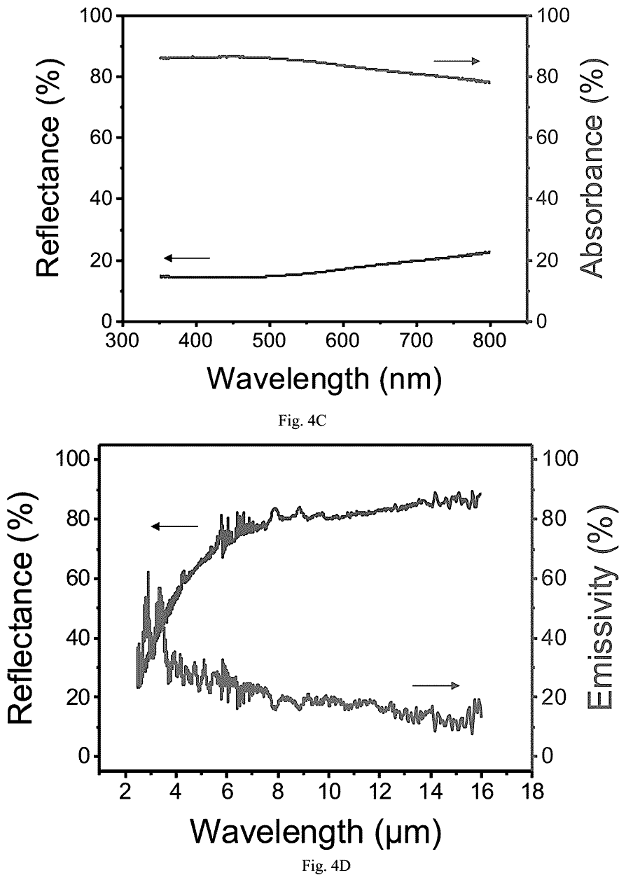

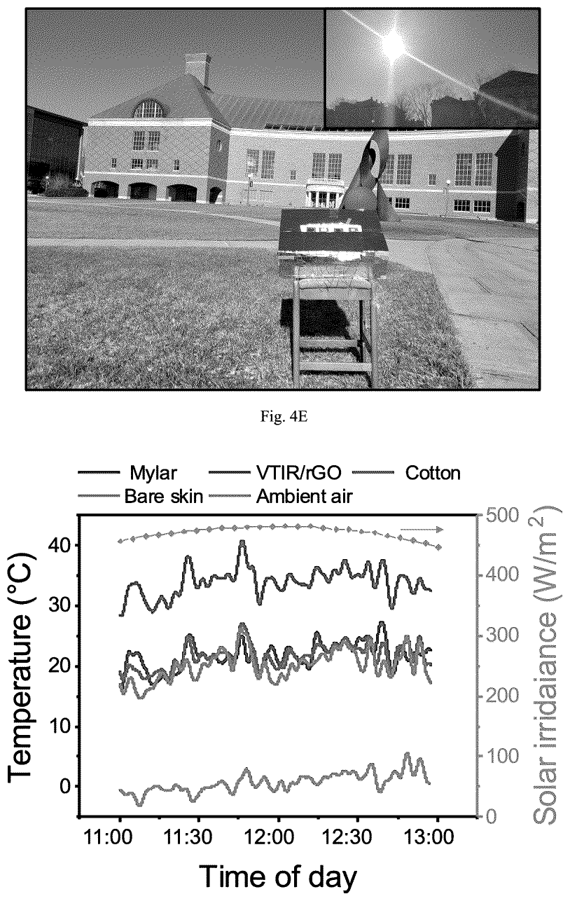

Next, to demonstrate the use of nano-mesh_OMO based VTIR coatings for daytime outdoor heating applications, the VTIR sample was laminated with rGO layer on the back (denoted as VTIR/rGO thereafter). rGO is known to have good photothermal conversion efficiency. Thus in this design, without wishing to be limited by any particular theory, the VTIR layer on the front may not only block the radiative heat loss from the skin to the environment but may also allow the transmission of solar light which may be subsequently absorbed by the rGO layer on the back and converted to thermal energy to warm up the human body (FIG. 4A). The photograph in FIG. 4B exhibits the dark black color of VTIR/rGO sample. UV-VIS characterization showed that VTIR/rGO can absorb more than 80% of solar energy in the visible wavelength region (FIG. 4C). In the meantime, the infrared reflectance of VTIR/rGO measured by FTIR remained a high value of about 80% in the mid-infrared region (FIG. 4D). Furthermore, thermal measurements in the daytime outdoor environment under direct sunlight demonstrated that the VTIR/rGO sample can maintain the skin temperature around 33° C. in cold weathers with low ambient temperatures around 0° C. and strong wind levels (FIGS. 4E and 4F). In contrast, the conventional cotton fabric and Mylar blanket showed much inferior warming performance in the same condition, which decreased the skin temperature to about 20° C. Without wishing to be limited by any particular theory, these thermal measurement results validate the effectiveness of using VTIR coatings to enable the combination of radiative heating and photothermal effects for superior passive heating of the human body.

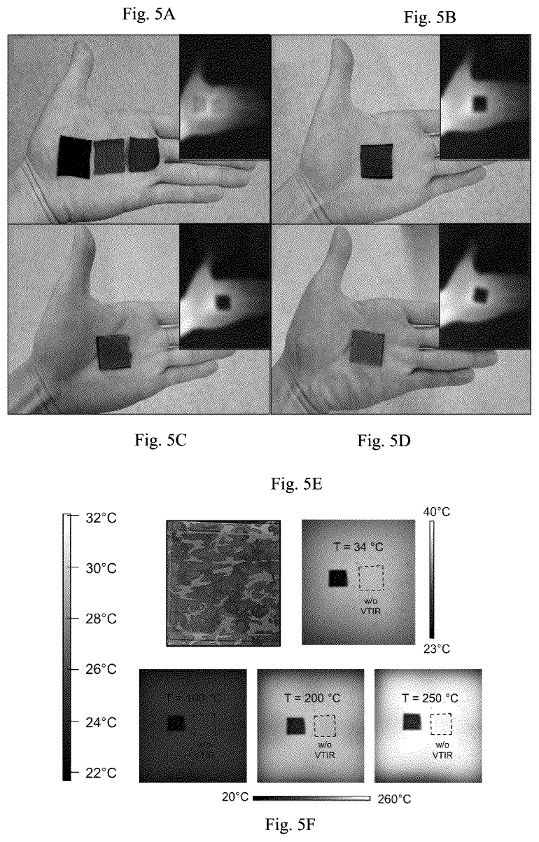

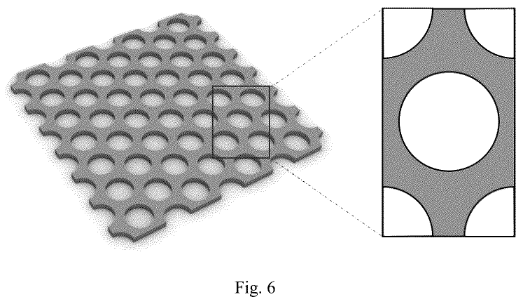

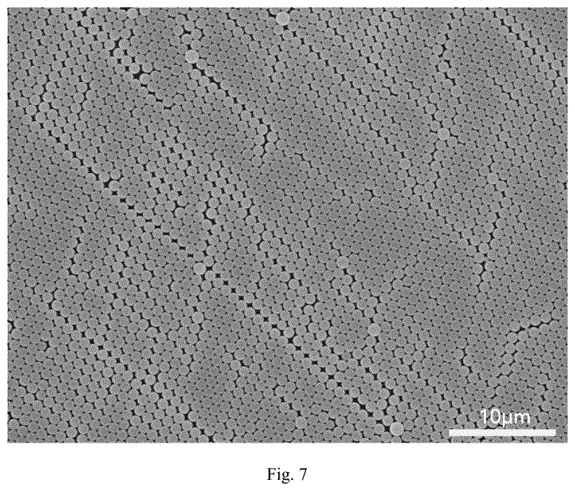

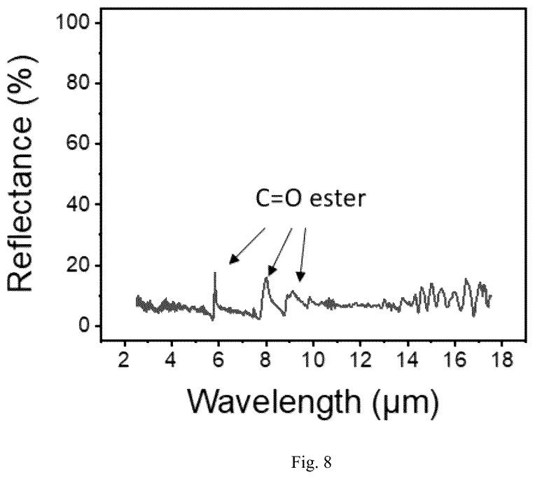

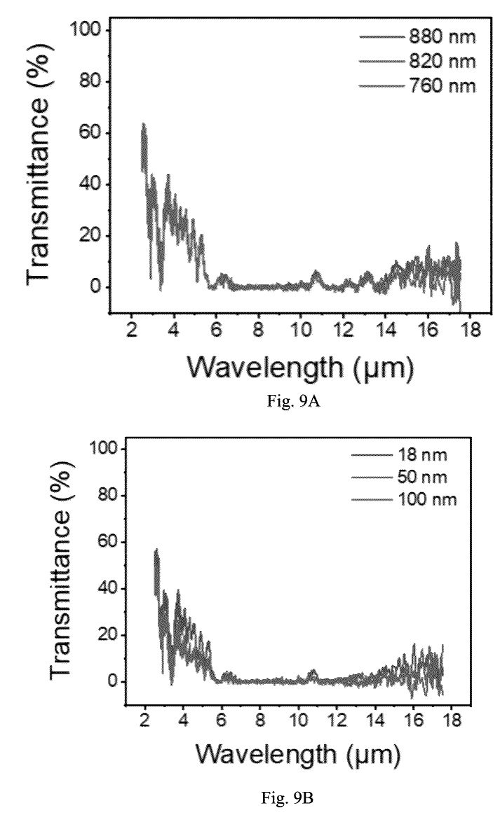

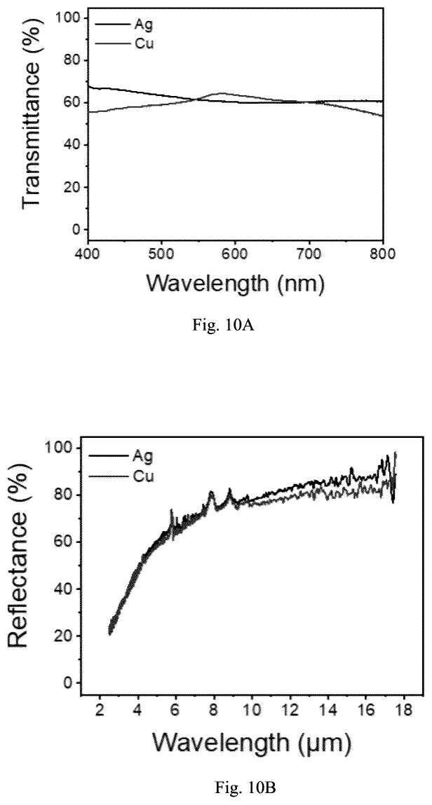

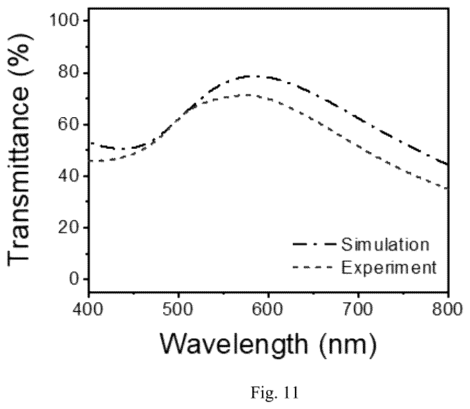

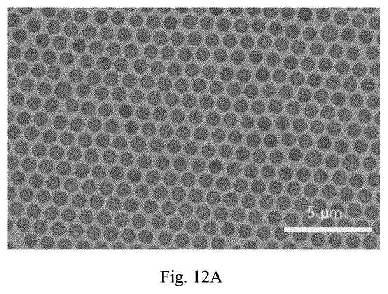

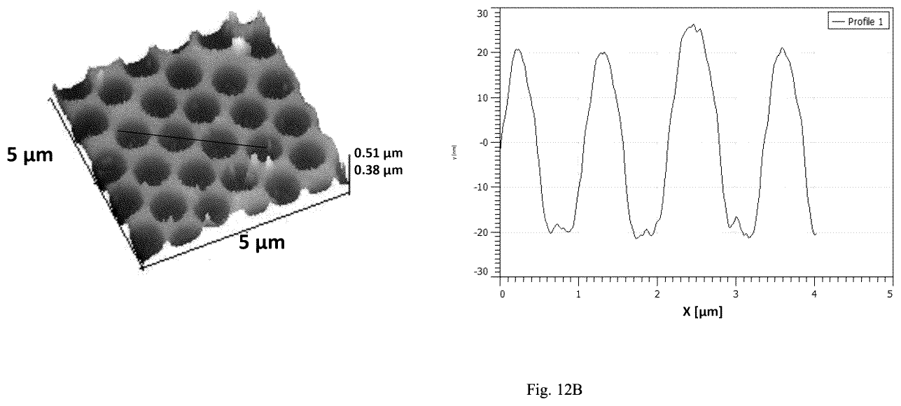

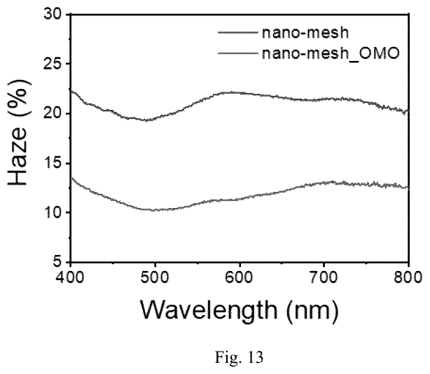

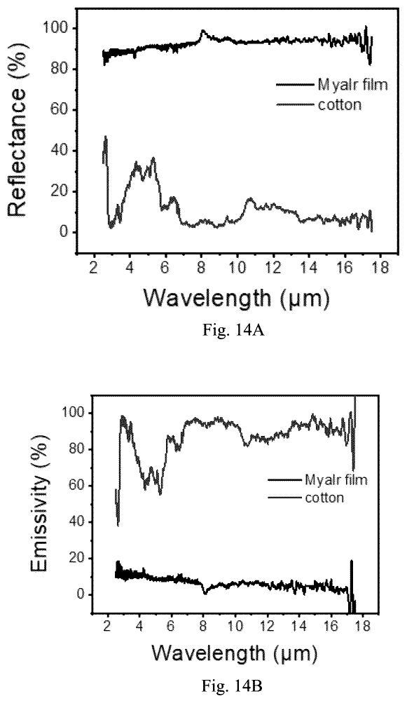

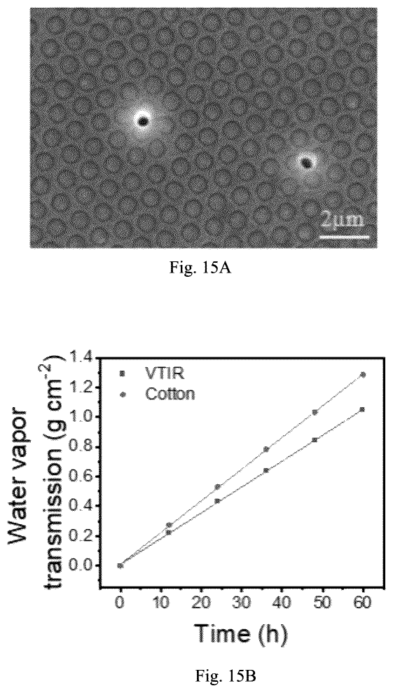

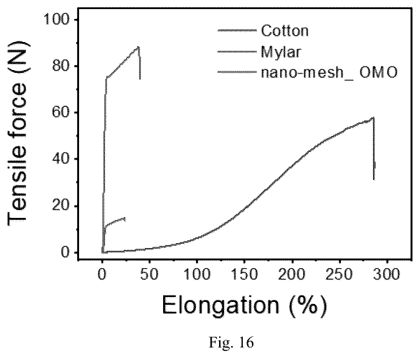

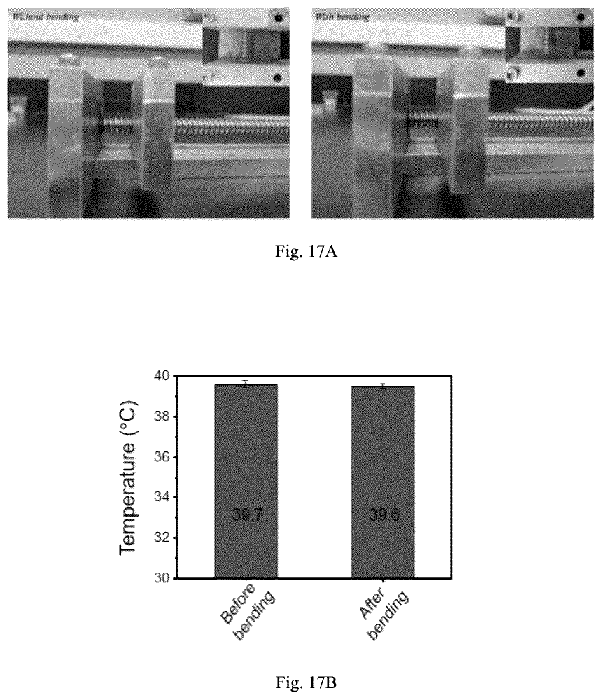

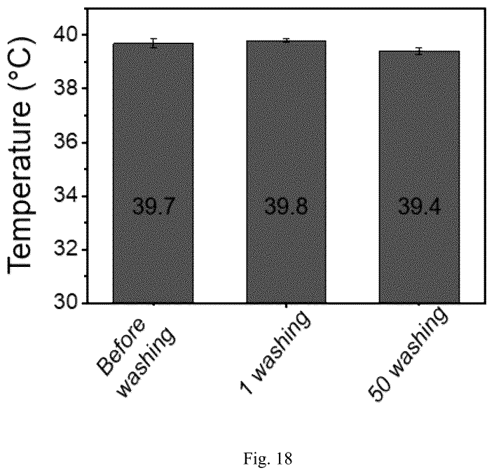

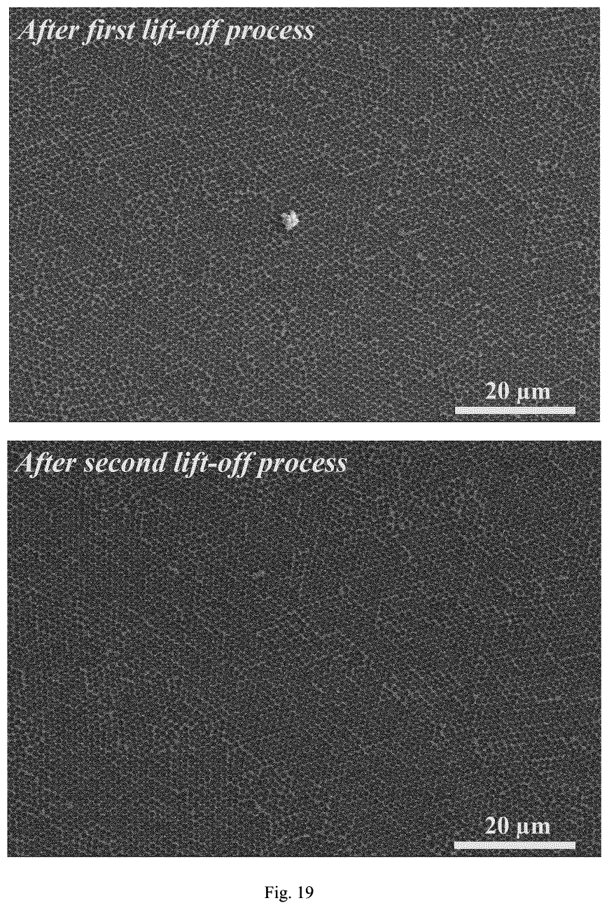

Furthermore, the capabilities of VTIR coatings to express different colors without affecting their radiative heating performance (FIGS. 5A-5D) was shown. To visualize the effect of radiative heating and coloration of VTIR, photographs and thermal images of colored cotton textiles with and without VTIR coatings placed on the skin surface were taken. In the photographs, colored textiles with VTIR coatings showed the same colors of black, red, and blue as normal cotton textiles. In the thermal images taken by an infrared camera, the skin area covered by normal colored cotton samples displayed a warm red color, indicating strong emission of thermal radiation similar to that of bare skin. On the other hand, the skin area covered by colored cotton with VTIR coatings displayed a dark purple color, signifying a much lower emission of human body heat radiation. Without wishing to be limited by any particular theory, the comparison by thermal imaging clearly shows that VTIR coatings can block human body thermal radiation for personal thermal management while fully retaining the color of normal textiles.

Finally, the thermal camouflage and visual camouflage effects of VTIR coatings was investigated. Textiles with visual camouflage pattern are often exploited for day-time cloaking purposes, but they fail to provide protection for the wearers or objects to avoid detection under infrared surveillance. In this application, silver instead of gold was used in the OMO structure to show that a variety of metals can be used for VTIR coatings. FIG. 5E shows the photograph and thermal imaging of a visible camouflage textile combined with VTIR coatings. Due to the high visible transmittance of VTIR coatings, the visual camouflage pattern is still revealed, preserving its day-time cloaking functionality. In addition, as shown in the thermal imaging, VTIR coatings can minimize the emission of thermal radiation from the surface at the skin temperature of 34° C. to the level comparable with that of the surrounding environment, allowing for night-time cloaking under an infrared detecting camera. Moreover, VTIR coatings achieved excellent thermal camouflage effects under various temperature conditions (100° C.-250° C.) by drastically reducing the thermal radiation for high-temperature objects (FIG. 5F). This indicates that the VTIR coatings could enable all-day camouflage on a variety of military objects, from military uniforms to vehicles, under various temperature environments. Without wishing to be limited by any particular theory, the VTIR coatings have demonstrated for the first time, independent control of visible transparency for IR-reflecting materials to enable synergistic combination of radiative heating with other functionalities: 1) coloration, 2) photothermal effect for outdoor heating, and 3) integrated visible and thermal camouflages for all-day cloaking (Table 1).

### LIST OF EMBODIMENTS

1. A coated article ((e.g., a textile mesh, reversible clothing, IR-resistant textile (such as IR-resistant camouflaged tarpaulin, IR-resistant clothing or gear)), comprising:
a sheet-like substrate comprising a first face and a second face opposite the first face (e.g., a film (such as a polymeric film), a textile (e.g., woven textile, non-woven, knitted, etc.); and
a multi-layer mesh structure disposed thereon, the mesh structure comprising:
   an optional patterned layer comprising a first metal or metal compound, (first metal layer), wherein when present said first metal layer is disposed on the substrate;
   an optional patterned layer comprising a first oxide, wherein said layer is the first or second layer (relative to the substrate) (first oxide layer), wherein when present said first oxide layer is either the first or second layer (relative to the substrate);
   a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
   an optional patterned layer comprising a second oxide, (second oxide layer), wherein when present said second oxide layer is either the third or fourth layer (relative to the substrate);
      wherein the mesh structure comprises a plurality of void areas extending therethrough;
      wherein a first void area extends axially away from the substrate along a first axis and a second void area extends axially away from the substrate along a second axis;
      wherein the first axis and the second axis each extends in a direction biased away from a line extending orthogonally away from the first face of the substrate;
   wherein the first layer is disposed on the substrate;
   wherein the first layer is disposed between the substrate and the second layer;
   wherein the second layer is disposed between the first layer and the third layer;
   wherein the third layer is disposed between the second layer and the fourth layer;
   wherein the fourth layer when present is disposed on the third layer.

2. The article of embodiment 1, wherein the substrate comprises a polymeric material.

3. The article of embodiment 2, wherein the polymeric material is polyolefin.

4. The article of embodiment 2, wherein the polymeric material is polyethylene terephthalate (PET).

5. The article of embodiment 1, wherein the substrate comprises a textile.

6. The article of embodiment 1, wherein the first oxide is an oxide chosen from the group: TiO2, indium tin oxide (ITO), Ta₂O₅, NiO, GaSnO, SrVOₓ, IGZO, ZnO, ZrON, MoO₃, WO₃ etc.

7. The article of embodiment 1, wherein the second oxide is an oxide chosen from the group: TiO2, indium tin oxide (ITO), Ta₂O₅, NiO, GaSnO, SrVOₓ, IGZO, ZnO, ZrON, MoO₃, WO₃, etc.

8. The article of embodiment 1, wherein the first layer comprises a metal.

9. The article of embodiment 1, wherein the third layer comprises a metal.

10. The article of embodiment 8, wherein the metal is chromium (Cr) or titanium (Ti).

11. The article of embodiment 9, wherein the metal is chosen from the group: Ag, Au, Cu, Al, Sn, W, etc.

12. The article of embodiment 1, wherein said plurality of void areas consists of two or more individual void areas.

13. The article of embodiment 1, wherein said individual void areas each have a continuous shape (e.g., cylindrical, octagonal, hexagonal.)

14. The article of embodiment 1, wherein said individual void areas each have an opening with a diameter between about 1 nm and about 2 microns, about 10 nm and about 20 microns, or about 100 nm and about 1 microns.

15. The article of embodiment 1, wherein said individual void areas each have an opening with a diameter between about 1 nm and about 800 nm, or about 1 nm and about 50 nm, about 100 nm and about 700 nm, or about 50 nm and about 750 nm.

16. The article of embodiment 1, wherein said individual void areas each have an opening with a diameter between 10 nm and 500 nm.

17. The article of embodiment 1, wherein said individual void areas each have an opening with a diameter between about 700 nm and 800 nm.

18. The article of embodiment 1, wherein the mesh structure permits transmission of at least about 40% of visible light in the range of about 300-800 nm, or about 400 nm to about 700 nm (e.g., about 550 nm) or at, least 80% of visible light in the range of about 300-800 nm, or about 400 nm to about 700 nm (e.g., about 550 nm).

19. The article of embodiment 1, wherein the plurality of void areas is disposed in a pattern (e.g., interconnected metal mesh, patterned pattern, etc.)

20. The article of embodiment 19, wherein the pattern is a regular/uniform pattern or irregular pattern.

21. The article of embodiment 1, wherein the article further comprises an adhesive disposed on the second face.

22. The article of embodiment 1, wherein the mesh structure is bonded to the substrate.

23. The article of embodiment 1, wherein the first layer has a thickness between about 0.1 nm and about 10 nm, or about 0.1 nm and about 100 nm.

24. The article of embodiment 1, wherein the third layer has a thickness between about 5 nm and 1 micron.

25. The article of embodiment 1, wherein the third layer has a thickness between about 10 nm and 200 nm.

26. The article of embodiment 1, wherein the second layer has a thickness less than 100 nm, about 0.001 nm to about 100 nm, or about 0.001 nm to about 10 nm, 0.01 nm to about 80 nm.

27. The article of embodiment 1, wherein the fourth layer has a thickness less than 100 nm.

28. The article of embodiment 1, wherein the second layer has a thickness between about 5 nm and 1 micron.

29. The article of embodiment 1, wherein the fourth layer has a thickness between about 5 nm and 1 micron.

30. The article of embodiment 1, wherein the second layer has a thickness between about 10 nm and 80 nm.

31. The article of embodiment 1, wherein the fourth layer has a thickness between about 10 nm and 80 nm.

32. The article of embodiment 1, wherein the first layer is thicker than the third layer (or wherein the third layer is thicker than the first layer.

33. The article of embodiment 1, wherein the second and fourth layers have the same thickness (or wherein the second and fourth layers have a different thickness.

34. A method for making a coated article (e.g., a textile mesh), the method comprising:
forming a monolayer of polymeric or ceramic beads on a substrate (e.g., film (such as a polymeric film e.g., polyethylene terephthalate (PET) or polyolefin), textile (e.g. woven textile, non-woven, knitted, etc.));
shrinking said beads to generate gaps to obtain a patterned substrate;
optionally, depositing a first metal layer (e.g., Cr or Ti) on said patterned substrate;
optionally, depositing a first oxide layer on said first metal layer;
depositing a second metal layer (e.g., Ag, Au, Cu, Al, Sn, W, etc.) on said first oxide layer or metal layer to obtain a multilayer mesh structure on said patterned substrate;
optionally, depositing a second oxide layer on said second metal layer;
lifting beads from said multilayer mesh structure on said patterned substrate to obtain a multilayer mesh structure on a sheet like substrate;
combining said multilayer mesh structure on a sheet like substrate with an article (e.g., a textile such as textile mesh, reversible clothing, IR-resistant textile (such as IR-resistant camouflaged tarpaulin, IR-resistant clothing or gear)).

35. The method of embodiment 34, wherein when the first oxide layer of step (d) is present then the metal layer of step (c) is not used.

36. The method of embodiment 34, further comprising a washing step including washing beads via a centrifugal washer.

37. The method of embodiment 36, wherein the beads are washed at about 4000 RPM and for about 10 minutes.

38. The method of embodiment 34, further comprising forming a solution including beads, alcohol (e.g., ethanol, methanol, etc.), and/or water.

39. The method of embodiment 34, wherein said shrinking step further comprises shrinking said beads with a shrinking medium chosen from: O₂, O₂/CF₄, O₂/CHF₃, CF₄, NH₃, CF₃, and SF₆, Shrinking may occur by for instance, reactive ion etching (RIE), SiO2 etching (e.g., using CF₄, SF₆, NH₃) or polymer etching (e.g., using O₂, O₂/CF₄, O₂/CHF₃).

40. The method of embodiment 34, wherein said metal is Cr.

41. The method of embodiment 34, wherein at least one of said depositing steps comprises e-beam deposition or sputtering.

42. The method of embodiment 34, wherein said polymeric beads is polystyrene (PS).

43. The method of embodiment 34, wherein said beads is a ceramic material.

44. The method of embodiment 34, wherein the first metal layer and/or second metal layer has a deposition thickness less than 5 nm or about 0.001 nm to about 5 nm, about 0.01 nm to about 2 nm, about 0.01 nm to about 1 nm, about 1 nm to about 5 nm, or about 0.01 nm to about 5 nm.

45. The method of embodiment 34, wherein the first metal layer and/or second metal layer has a deposition thickness between about 0.1 nm and 10 nm.

46. The method of embodiment 34, wherein the first metal layer and/or second metal layer has a deposition thickness between about 0.1 nm and 5 nm.

47. The method of embodiment 34, wherein second metal layer has a thickness of 5 nm, 10 nm, about 1 nm to about 100 nm.

48. The method of embodiment 34, wherein the first metal layer and the second metal layer, independently, have thickness of between about 5 nm and 1 micron.

49. The method of embodiment 34, wherein the first metal layer and the second metal layer, independently, have a thickness of between about 10 nm and 200 nm.

50. The method of embodiment 34, wherein the first oxide layer and the second oxide layer, independently, have a thickness less than 100 nm.

51. The method of embodiment 34, wherein the first oxide layer and the second oxide layer, independently, have a thickness between about 5 nm and about 1 micron, about 5 nm and about 400 micron, or about 400 nm and about 1 micron.

52. The method of embodiment 34, wherein the first oxide layer and the second oxide layer, independently, have a thickness between about 10 nm and about 80 nm, or about 20 nm and about 70 nm, or about 40 nm and about 80 nm.

53. A method for making a coated article (e.g., a textile mesh), the method comprising:
forming a monolayer of beads on a substrate;
shrinking said beads to obtain a patterned substrate;
depositing an oxide layer on said patterned substrate;
depositing a metal layer thereon said patterned substrate;
depositing an oxide layer thereon said patterned substrate to obtain to a multilayer mesh structure on said patterned substrate;
lifting a multilayer mesh structure on a sheet-like substrate.

54. A method for making a coated article (e.g., a textile mesh), the method comprising:
forming a monolayer of polymeric or ceramic beads on a substrate;
shrinking said beads to obtain a patterned substrate;
depositing a metal layer (e.g., Cr or Ti) thereon said patterned substrate;
depositing an oxide layer thereon said substrate;
depositing a metal layer (e.g., Ag, Au, Cu, Al, Sn, W) thereon said substrate;
depositing an oxide layer thereon said to obtain a multilayer mesh structure on said patterned substrate;
lifting a multilayer mesh structure on a sheet like substrate;
combining said multilayer mesh structure on a sheet like substrate with an article.

55. An article, comprising:
a sheet-like substrate comprising a first face and a second face opposite the first face; and
a multi-layer mesh structure disposed thereon, the mesh structure comprising:
   a patterned first layer comprising a first oxide, the first layer being disposed on the substrate;
   a patterned second layer comprising a metal or metal compound, wherein the first layer is disposed between the substrate and the second layer;
   and a patterned third layer comprising a second oxide, wherein the second layer is disposed between the first layer and the third layer;
   wherein the mesh structure comprises a plurality of void areas extending therethrough;
   wherein a first void area extends axially away from the substrate along a first axis and a second void area extends axially away from the substrate along a second axis;
   wherein the first axis and the second axis each extends in a direction biased away from a line extending orthogonally away from the first face of the substrate.

56. A VTIR coating, said coating comprising:
a sheet-like substrate comprising a first face and a second face opposite the first face; and
a multi-layer mask structure disposed thereon, the mask structure comprising:
   an optional discontinuous first layer comprising a first metal or metal compound, the first layer being disposed on the substrate;
   an optional discontinuous second layer comprising a first oxide, wherein the first layer is disposed between the substrate and the second layer;
   a discontinuous third layer comprising a second metal or metal compound, wherein the second layer is disposed between the first layer and the third layer;
   and an optional discontinuous fourth layer comprising a second oxide, wherein the fourth layer is disposed subjacent said third layer;
   wherein the mask structure comprises a plurality of void areas extending therethrough;
   wherein a first void area extends axially away from the substrate along a first axis and a second void area extends axially away from the substrate along a second axis;
   wherein the first axis and the second axis each extends in a direction biased away from a line extending orthogonally away from the first face of the substrate.

57. A method of preparing a VTIR coating, said method comprising forming a monolayer of polymeric or ceramic beads on a substrate;
shrinking said beads to obtain a patterned substrate;
depositing a metal layer (e.g., Cr or Ti) thereon said patterned substrate;
depositing an oxide layer thereon said patterned substrate;
depositing a metal layer (e.g., Ag, Au, Cu, Al, Sn, W) thereon said patterned substrate;
depositing an oxide layer thereon said patterned substrate;
lifting a multilayer mesh structure on a sheet like substrate.

58. A method for a VTIR coating, the method comprising:
forming a monolayer of polymeric or ceramic beads on a substrate;
shrinking said beads to obtain a patterned substrate;
optionally, depositing a first metal layer (e.g., Cr or Ti) on said patterned substrate;
optionally, depositing a first oxide layer on said first metal layer;
depositing a metal layer (e.g., Ag, Au, Cu, Al, Sn, W, etc.) (either directly on said patterned substrate of step (b), on said first metal layer of step (c), or on said first oxide layer of step (d)) to obtain a multilayer mesh structure on a patterned substrate;
optionally, depositing a second oxide layer on said second metal layer.

59. A method of providing thermal camouflage comprising using an article of embodiment 1 to thermally obscure a subject or an object.

60. The article of embodiment 1, wherein said article is camouflage textile.

61. The article of embodiment 1, wherein said article provides a high mid-infrared reflectance of at least 40%.

62. The coated article according to embodiment 1, said coated article comprising:
A sheet-like substrate comprising a first face and a second face opposite the first face (e.g., a film (such as a polymeric film), a textile (e.g., woven textile, non-woven, knitted, etc.); and a multi-layer mesh structure disposed thereon, the mesh structure comprising:
   an optional patterned layer comprising a first metal or metal compound, (first metal layer), wherein when present said first metal layer is disposed on the substrate; an optional patterned layer comprising a first oxide, wherein said layer is the first or second layer (relative to the substrate) (first oxide layer), wherein when present said first oxide layer is either the first or second layer (relative to the substrate);
   a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
   a patterned layer comprising a second oxide, (second oxide layer), wherein when present said second oxide layer is either the third or fourth layer (relative to the substrate);
      wherein the mesh structure comprises a plurality of void areas extending therethrough;
      wherein a first void area extends axially away from the substrate along a first axis and a second void area extends axially away from the substrate along a second axis;
      wherein the first axis and the second axis each extends in a direction biased away from a line extending orthogonally away from the first face of the substrate;
   wherein the first layer is disposed on the substrate;
   wherein the first layer is disposed between the substrate and the second layer;
   wherein the second layer is disposed between the first layer and the third layer;
   wherein the third layer is disposed between the second layer and the fourth layer;
   wherein the fourth layer when present is disposed on the third layer.

63. The coated article according to embodiment 1, said coated article comprising:
a sheet-like substrate comprising a first face and a second face opposite the first face (e.g., a film (such as a polymeric film), a textile (e.g., woven textile, non-woven, knitted, etc.); and
a multi-layer mesh structure disposed thereon, the mesh structure comprising:
   an optional patterned layer comprising a first metal or metal compound, (first metal layer), wherein when present said first metal layer is disposed on the substrate;
   a patterned layer comprising a first oxide, wherein said layer is the first or second layer (relative to the substrate) (first oxide layer), wherein when present said first oxide layer is either the first or second layer (relative to the substrate);
   a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
   a patterned layer comprising a second oxide, (second oxide layer), wherein when present said second oxide layer is either the third or fourth layer (relative to the substrate);
      wherein the mesh structure comprises a plurality of void areas extending therethrough;
      wherein a first void area extends axially away from the substrate along a first axis and a second void area extends axially away from the substrate along a second axis;
      wherein the first axis and the second axis each extends in a direction biased away from a line extending orthogonally away from the first face of the substrate;
   wherein the first layer is disposed on the substrate;
   wherein the first layer is disposed between the substrate and the second layer;
   wherein the second layer is disposed between the first layer and the third layer;
   wherein the third layer is disposed between the second layer and the fourth layer;
   wherein the fourth layer when present is disposed on the third layer.

64. The coated article according to embodiment 1, said coated article comprising:
A sheet-like substrate comprising a first face and a second face opposite the first face (e.g., a film (such as a polymeric film), a textile (e.g., woven textile, non-woven, knitted, etc.); and a multi-layer mesh structure disposed thereon, the mesh structure comprising:
   a patterned layer comprising a first metal or metal compound, (first metal layer), wherein when present said first metal layer is disposed on the substrate;
   a patterned layer comprising a first oxide, wherein said layer is the first or second layer (relative to the substrate) (first oxide layer), wherein when present said first oxide layer is either the first or second layer (relative to the substrate);
   a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
   an optional patterned layer comprising a second oxide, (second oxide layer), wherein when present said second oxide layer is either the third or fourth layer (relative to the substrate);
      wherein the mesh structure comprises a plurality of void areas extending therethrough;
      wherein a first void area extends axially away from the substrate along a first axis and a second void area extends axially away from the substrate along a second axis;
      wherein the first axis and the second axis each extends in a direction biased away from a line extending orthogonally away from the first face of the substrate;
   wherein the first layer is disposed on the substrate;
   wherein the first layer is disposed between the substrate and the second layer;
   wherein the second layer is disposed between the first layer and the third layer;
   wherein the third layer is disposed between the second layer and the fourth layer;
   wherein the fourth layer when present is disposed on the third layer.

65. The coated article according to embodiment 1, said coated article comprising:
a sheet-like substrate comprising a first face and a second face opposite the first face (e.g., a film (such as a polymeric film), a textile (e.g., woven textile, non-woven, knitted, etc.); and
a multi-layer mesh structure disposed thereon, the mesh structure comprising:
   a patterned layer comprising a first metal or metal compound, (first metal layer), wherein when present said first metal layer is disposed on the substrate;
   an optional patterned layer comprising a first oxide, wherein said layer is the first or second layer (relative to the substrate) (first oxide layer), wherein when present said first oxide layer is either the first or second layer (relative to the substrate);
   a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
   a patterned layer comprising a second oxide, (second oxide layer), wherein when present said second oxide layer is either the third or fourth layer (relative to the substrate);
      wherein the mesh structure comprises a plurality of void areas extending therethrough;
      wherein a first void area extends axially away from the substrate along a first axis and a second void area extends axially away from the substrate along a second axis;
      wherein the first axis and the second axis each extends in a direction biased away from a line extending orthogonally away from the first face of the substrate;
   wherein the first layer is disposed on the substrate;
   wherein the first layer is disposed between the substrate and the second layer;
   wherein the second layer is disposed between the first layer and the third layer;
   wherein the third layer is disposed between the second layer and the fourth layer;
   wherein the fourth layer when present is disposed on the third layer.

66. The coated article according to embodiment 1, said coated article comprising:
a sheet-like substrate comprising a first face and a second face opposite the first face (e.g., a film (such as a polymeric film), a textile (e.g., woven textile, non-woven, knitted, etc.); and
a multi-layer mesh structure disposed thereon, the mesh structure comprising:
   an optional patterned layer comprising a first metal or metal compound, (first metal layer), wherein when present said first metal layer is disposed on the substrate;
   a patterned layer comprising a first oxide, wherein said layer is the first or second layer (relative to the substrate) (first oxide layer), wherein when present said first oxide layer is either the first or second layer (relative to the substrate);
   a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
   an optional patterned layer comprising a second oxide, (second oxide layer), wherein when present said second oxide layer is either the third or fourth layer (relative to the substrate);
      wherein the mesh structure comprises a plurality of void areas extending therethrough;
      wherein a first void area extends axially away from the substrate along a first axis and a second void area extends axially away from the substrate along a second axis;
      wherein the first axis and the second axis each extends in a direction biased away from a line extending orthogonally away from the first face of the substrate;
      wherein the first layer is disposed on the substrate;
      wherein the first layer is disposed between the substrate and the second layer;
      wherein the second layer is disposed between the first layer and the third layer;
      wherein the third layer is disposed between the second layer and the fourth layer;
      wherein the fourth layer when present is disposed on the third layer.

67. The coated article according to embodiment 1, said coated article comprising:
A sheet-like substrate comprising a first face and a second face opposite the first face (e.g., a film (such as a polymeric film), a textile (e.g., woven textile, non-woven, knitted, etc.); and
   a multi-layer mesh structure disposed thereon, the mesh structure comprising:
      a patterned layer comprising a first metal or metal compound, (first metal layer), wherein when present said first metal layer is disposed on the substrate;
      an optional patterned layer comprising a first oxide, wherein said layer is the first or second layer (relative to the substrate) (first oxide layer), wherein when present said first oxide layer is either the first or second layer (relative to the substrate);
      a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
      an optional patterned layer comprising a second oxide, (second oxide layer), wherein when present said second oxide layer is either the third or fourth layer (relative to the substrate);
         wherein the mesh structure comprises a plurality of void areas extending therethrough;
         wherein a first void area extends axially away from the substrate along a first axis and a second void area extends axially away from the substrate along a second axis;
         wherein the first axis and the second axis each extends in a direction biased away from a line extending orthogonally away from the first face of the substrate;
         wherein the first layer is disposed on the substrate;
         wherein the first layer is disposed between the substrate and the second layer;
         wherein the second layer is disposed between the first layer and the third layer;
         wherein the third layer is disposed between the second layer and the fourth layer;
         wherein the fourth layer when present is disposed on the third layer.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.

All publications mentioned herein are incorporated by reference to the extent they support the present invention.

What is claimed is:

1. A coated article, said article comprising:
a. a sheet-like substrate comprising a first face and a second face opposite the first face; and
b. a multi-layer mesh structure disposed thereon, the mesh structure comprising:
i. an optional patterned layer comprising a first metal or metal compound, (first metal layer), wherein when present said first metal layer is disposed on the substrate;
ii. an optional patterned layer comprising a first oxide, wherein said layer is the first or second layer (relative to the substrate) (“first oxide layer”), wherein when present said first oxide layer is either the first or second layer (relative to the substrate);
iii. a patterned layer comprising a metal or metal compound, wherein said patterned layer is either (a) a first metal layer disposed between the first oxide layer and second oxide layer, or (b) a second metal layer disposed between the first oxide layer and a second oxide layer, wherein said patterned layer is the second or third layer (relative to the substrate);
iv. an optional patterned layer comprising a second oxide (“second oxide layer”), wherein when present said second oxide layer is either the third or fourth layer (relative to the substrate);
wherein the mesh structure comprises a plurality of void areas extending therethrough;
wherein a first void area extends axially away from the substrate along a first axis and a second void area extends axially away from the substrate along a second axis;
wherein the first axis and the second axis each extends in a direction biased away from a line extending orthogonally away from the first face of the substrate;
wherein the first layer is disposed on the substrate;
wherein the first layer is disposed between the substrate and the second layer;
wherein the second layer is disposed between the first layer and the third layer;
wherein the third layer is disposed between the second layer and the fourth layer;
wherein the fourth layer when present is disposed on the third layer.

2. The article of claim 1, wherein the substrate comprises a polymeric material.

3. The article of claim 2, wherein the polymeric material is polyolefin.

4. The article of claim 2, wherein the polymeric material is polyethylene terephthalate (PET).

5. The article of claim 1, wherein the substrate comprises a textile.

6. The article of claim 1, wherein the first oxide is an oxide chosen from the group: TiO₂, indium tin oxide (ITO), Ta₂O₅, NiO, GaSnO, SrVOₓ, IGZO, ZnO, ZrON, MoO₃, and WO₃.

7. The article of claim 1, wherein the second oxide is an oxide chosen from the group: TiO₂, indium tin oxide (ITO), Ta₂O₅, NiO, GaSnO, SrVOₓ, IGZO, ZnO, ZrON, MoO₃, and WO₃.

8. The article of claim 1, wherein the first layer comprises a metal.

9. The article of claim 1, wherein the third layer comprises a metal.

10. The article of claim 8, wherein the metal is chromium (Cr) or titanium (Ti).

11. The article of claim 9, wherein the metal is chosen from the group: Ag, Au, Cu, Al, Sn, and W.

12. The article of claim 1, wherein the mesh structure permits transmission of at least 40% of visible light in the range of about 300-800 nm or at, least 80% of visible light in the range of about 300-800 nm.

13. A method for making a coated article (e.g., a textile mesh), the method comprising:
a. forming a monolayer of polymeric or ceramic beads on a substrate;
b. shrinking said beads to generate gaps to obtain a patterned substrate;
c. optionally, depositing a first metal layer on said patterned substrate;
d. optionally, depositing a first oxide layer on said first metal layer;
e. depositing a second metal layer on said first oxide layer or metal layer to obtain a multilayer mesh structure on said patterned substrate;
f. optionally, depositing a second oxide layer on said second metal layer;
g. lifting beads from said multilayer mesh structure on said patterned substrate to obtain a multilayer mesh structure on a sheet like substrate;
h. combining said multilayer mesh structure on a sheet like substrate with an article.

14. The method of claim 13, wherein when the first oxide layer of step (d) is present then the metal layer of step (c) is not used.

15. The method of claim 13, further comprising forming a solution including beads, alcohol, and/or water.

16. The method of claim 13, wherein said shrinking step further comprises shrinking said beads with a shrinking medium chosen from: O₂, O₂/CF₄, O₂/CHF₃, CF₄, NH₃, CF₃, and SF₆.

17. The article according to claim 1, said article comprising:
a. a sheet-like substrate comprising a first face and a second face opposite the first face; and
b. a multi-layer mesh structure disposed thereon, the mesh structure comprising:
i. a patterned first layer comprising a first oxide, the first layer being disposed on the substrate;
ii. a patterned second layer comprising a metal or metal compound, wherein the first layer is disposed between the substrate and the second layer;
iii. and a patterned third layer comprising a second oxide, wherein the second layer is disposed between the first layer and the third layer;
iv. wherein the mesh structure comprises a plurality of void areas extending therethrough;
v. wherein a first void area extends axially away from the substrate along a first axis and a second void area extends axially away from the substrate along a second axis;
vi. wherein the first axis and the second axis each extends in a direction biased away from a line extending orthogonally away from the first face of the substrate.

18. A VTIR coating, said mesh structure comprising:
a. a sheet-like substrate comprising a first face and a second face opposite the first face; and
b. a multi-layer mask structure disposed thereon, the mask structure comprising:
i. an optional discontinuous first layer comprising a first metal or metal compound, the first layer being disposed on the substrate;
ii. an optional discontinuous second layer comprising a first oxide, wherein the first layer is disposed between the substrate and the second layer;
iii. a discontinuous third layer comprising a second metal or metal compound, wherein the second layer is disposed between the first layer and the third layer; and
iv. an optional discontinuous fourth layer comprising a second oxide, wherein the fourth layer is disposed subjacent said third layer;
wherein the mask structure comprises a plurality of void areas extending therethrough;
wherein a first void area extends axially away from the substrate along a first axis and a second void area extends axially away from the substrate along a second axis;
wherein the first axis and the second axis each extends in a direction biased away from a line extending orthogonally away from the first face of the substrate.
